(19) United States
(12) Patent Application Publication
(10) Pub. No.: US 2011/0145740 A1
(43) Pub. Date: Jun. 16, 2011

(54) Predictive Performance Calculator Apparatus and Method

(76) Inventor: Geoffrey McCue, Lawrence, KS (US)

(21) Appl. No.: 12/636,305

(22) Filed: Dec. 11, 2009

(51) Int. Cl. G06F 3/048; G06F 17/30

(52) U.S. Cl. 715/764; 707/770; 707/E17.032; 707/E17.014

(57) ABSTRACT

An apparatus and method to calculate and display future performance of an individual using user-inputted information so that it can be anticipated when the individual will be at maximum and minimum performance levels based on user-inputted information, and strategic decisions can be made as to whether or not to use the individual in a military operation, athletic event, or other like situation requiring heightened performance. Future performance may be calculated for a group of individuals to predict when the group will be at maximum and minimum performance levels.

### BACKGROUND OF THE INVENTION

The present general inventive concept relates to an apparatus and method of calculating future performance, and in particular, to a calculator apparatus and method that enables a user to calculate when an individual will be at maximum and minimum performance levels based on user-inputted data.

Performance levels of humans are commonly believed to run in cycles, which are referred to as “biorhythms.” A biorhythm takes into account ones physiological, emotional, or intellectual well-being or prowess.

Biorhythms are said to control or initiate various biological processes and are classically composed of three cyclic rhythms that are said to govern human behavior and demonstrate innate periodicity in natural physiological change: the physical, the emotional, and the intellectual or mental cycles.

Basic biorhythms follow certain facets of physiological cycles, though they may include others, and the details may vary depending on the source. The three classical cycles of biorhythms are endogenous infradian rhythms. The theory's basis lies in physiological and emotional cycles. They are often represented graphically as either symmetric or asymmetric waveforms, though most theories rely on symmetric forms.

By calculating or charting the biorhythm of a user, the user may strategically make decisions based on such. For instance, if performance of the user during a first period of time is high, the user may choose to schedule an examination requiring peak intellectual performance, or may schedule a sports competition requiring peak physical performance so that such coincides with the user's first period of time.

On the other hand, if during a second period of time, the user's intellectual level or physical performance level is low, the user may reschedule the examination or sports competition so that such coincides with a time other than the second period of time.

Some companies may chart the biorhythm calculations of their employees to forecast performance. For instance, airline companies may chart the biorhythms of their pilots and base especially long-distance flights requiring especially peak performance during periods of time corresponding with the pilots' peak performance levels.

Biorhythms may be related to bioelectricity and its interactions in the body. Consequently, the most commonly used charting form is the sinusoidal waveform, which is thought to be a plausible representation of a bioelectric activity cycle. Due to this sinusoidal nature, the cyclical flow of bioelectric activity undergoes periodic reverses in direction. Each cycle oscillates between a positive phase, e.g., 0% . . . 100%, and a negative phase, e.g., −100% . . . 0%, during which bioelectric activity strengthens and weakens.

The waveforms start, in most theories, at the neutral baseline (0%) at the time of birth of each individual. Each day that the waveform again crosses this baseline is dubbed a critical day, which means that tasks in the domain of the cycle are far more erratic than on other non-critical days. The purpose of mapping the biorhythmic cycles is to enable the calculation of critical days for performing or avoiding various activities.

The classical definition states that one's birth is an unfavorable circumstantial event, as is the day about 58 years later when the three cycles are again synchronised at their minimum values. According to the classical definition, the theory is assumed to apply only to humans. In the classical theory, the value of each cycle can be calculated at any given time in the life of an individual, and there are web sites that do exactly that.

Conventional human biorhythm calculators operate by calculating peaks and valleys in physical, emotional, and psychological states of a user exclusively based on the user's birth date after entry thereof.

The basis for using the user's birth date as a calculation date is based on the theory that the user's cycles start at a middle point at birth and then travel downwards or upwards at various rates throughout the user's life.

Conventional charting methods and calculators that calculate human biorhythm are flawed for at least the reason that conventional calculators assume that one's birth date is a constant, that is, without factoring in the possibility that one may have been born earlier or later than scheduled. There are numerous factors that may cause premature or delayed birth. Consequently, it is common for a birth to occur on a date different from an expected birth date, e.g., earlier or later than the expected birth date, which creates a fundamental inaccuracy in conventional human biorhythm calculators.

Therefore, it is desirable to provide a new and unique human biorhythm calculator that provides increased accuracy in determining biorhythms and to accurately chart biorhythms.

### SUMMARY OF THE INVENTION

The present general inventive concept provides a new and unique human biorhythm calculator that provides increased accuracy in determining biorhythms and to accurately chart biorhythms.

The present general inventive concept further provides a predictive performance calculator apparatus and method that is easy to manufacture and easy to use.

The foregoing and/or other aspects of the present general inventive concept may be achieved by providing a computer readable recording medium comprising computer readable codes to calculate and display a performance level, including querying a first user multiple times over a first period of time by displaying a set of predetermined questions, tracking performance of the first user over the first period of time, displaying a first plurality of fields to permit entry of information specific to the first user, calculating the performance level based on the information specific to the first user to yield a first personalized result, analyzing the first personalized result to identify a first user cycle within the first period of time, forecasting a future performance level based on the first user cycle, and displaying the first user future performance level in the form of a first graph.

The foregoing and/or other aspects of the present general inventive concept may further be achieved by querying a second user multiple times over a first period of time by displaying the set of predetermined questions, tracking performance of the second user over the first period of time, displaying a second plurality of fields to permit entry of information specific to the second user, calculating the performance level based on the information specific to the second user to yield a second personalized result, analyzing the second personalized result to identify a second user cycle within the first period of time, forecasting a second user future performance level based on the second user cycle, displaying the second user future performance level in the form of a second graph, comparing the first graph with the second graph, and yielding a determination with respect to whether the performance level of the first user coincides with the performance level of the second user, and recommending a course of action based on the determination

If the performance level of the first user coincides with the performance level of the second user, then a negative indicator may be displayed, and if the performance level of the first user coincides with the performance level of the second user, then a positive indicator may be displayed.

The performance level of the first user may coincide with the performance level of the second user if the performance level of the first user is aligned with the performance level of the second user.

The performance level of the first user may not coincide with the performance level of the second user if the performance level of the first user are not aligned with the performance level of the second user.

The information specific to the user may be attributes of the first user.

Results from the present general inventive concept may be used to group individuals with similar predicted performance levels.

Past performance may be used to as a factor to calculate future performance.

The present general inventive concept may be used to calculate peaks and/or valleys in one's performance level over a period of time in the future.

Results of the present general inventive concept may be confirmed and/or adjusted by analyzing past performance levels of a user such that any accuracies and/or inaccuracies in the past performance levels may be respectively verified and/or adjusted to aid in the calculation of future performance levels of the user.

The first period of time may be 60 days.

The set of predetermined questions may relate to one of physical, emotional, and mental attributes or all of physical, emotional, and mental attributes of the first user.

The set of predetermined questions may relate to one of physical, emotional, and mental attributes or all of physical, emotional, and mental attributes of the second user.

The cycle may have a start date of the cycle between 28 and 31 days.

The course of action may be to combine the first user and the second user or to separate the first user and the second user.

The course of action may be to recommend that the first user and the second user work together in one of an athletic competition, a military initiative, and a business venture, and/or may be to recommend that the first user and the second user do not work together in one of an athletic competition, a military initiative, and a business venture.

Additional aspects and utilities of the present general inventive concept will be set forth in part in the description which follows and, in part, will be obvious from the description, or may be learned by practice of the general inventive concept.

The foregoing and other objects are intended to be illustrative of the present general inventive concept and are not meant in a limiting sense. Many possible embodiments of the present general inventive concept may be made and will be readily evident upon a study of the following specification and accompanying drawings comprising a part thereof. Various features and subcombinations of present general inventive concept may be employed without reference to other features and subcombinations. Other objects and advantages of this present general inventive concept will become apparent from the following description taken in connection with the accompanying drawings, wherein is set forth by way of illustration and example, an embodiment of this present general inventive concept.

### BRIEF DESCRIPTION OF THE DRAWINGS

These and/or other aspects and utilities of the present general inventive concept will become apparent and more readily appreciated from the following description of the embodiments, taken in conjunction with the accompanying drawings of which:

FIG. 1 is a flowchart of the present general inventive concept.

FIG. 2 is a flowchart of the present general inventive concept.

FIG. 3 is a flowchart of the present general inventive concept.

FIG. 4 is a flowchart of the present general inventive concept illustrating various inputs, processing, and output.

FIG. 5 is graph of the present general inventive concept illustrating an example output for a plurality of individual units.

FIG. 6 is a flowchart of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to like elements throughout. The embodiments are described below in order to explain the present general inventive concept by referring to the figures.

The present general inventive concept provides a predictive performance calculator apparatus and method that executes a plurality of steps to determine a user performance level.

The first step executed by the present general inventive concept is to request information from a user over a period of time, such as 60 days, using predetermined criteria by querying the user multiple times over the period of time.

It is foreseen that only the user may be queried only a single time, but such is dependent upon the user's ability to recall information from the past that might be difficult to recollect. Consequently, the preferred embodiment of the present general inventive concept queries the user at least twice over the period of time.

Examples of predetermined criteria include, but are not limited to: user type, e.g., athlete, military, employee/employer, individual; number of users; day of birth for each user, present date to calculate age of each user and time of year; cycle to be calculated, e.g., 23-33 days; present latitude and longitude, i.e. present location; future latitude and longitude, i.e. future location; and/or occupation, e.g., airline pilot.

The second step executed by the present general inventive concept is permitting the user to enter information responsive to the queries into a plurality of entry fields that are each correspond to a specific query.

The third step executed by the present general inventive concept is analyzing the entered information to identify commonalities or a trend. In this manner, a 30-day cycle can be identified from the 60 days of entered information.

The fourth step is calculating a biorhythm of the user based on the identified cycle, which includes predicted performance.

The fifth step executed by the present general inventive concept is charting the biorhythm of the user including predicted performance and displaying the biorhythm of the user via a display.

It is foreseen that the display reviewing the display could be a digital display or a printout, or the like to permit the user to view the biorhythm to apprise the user of the user's, future performance levels based on a user biorhythm.

It is foreseen that all or just a portion of the aforementioned steps may be employed without deviating from the scope of the present general inventive concept.

In use, the present general inventive concept may be used to determine a group dynamic such that a first individual with a low performance level may be grouped with a second individual having a peak performance level, thereby allowing the second individual to offset the low performance level of the first user. The group dynamic can be obtained by repeating the above steps for each individual within the group to obtain results and then comparing the results.

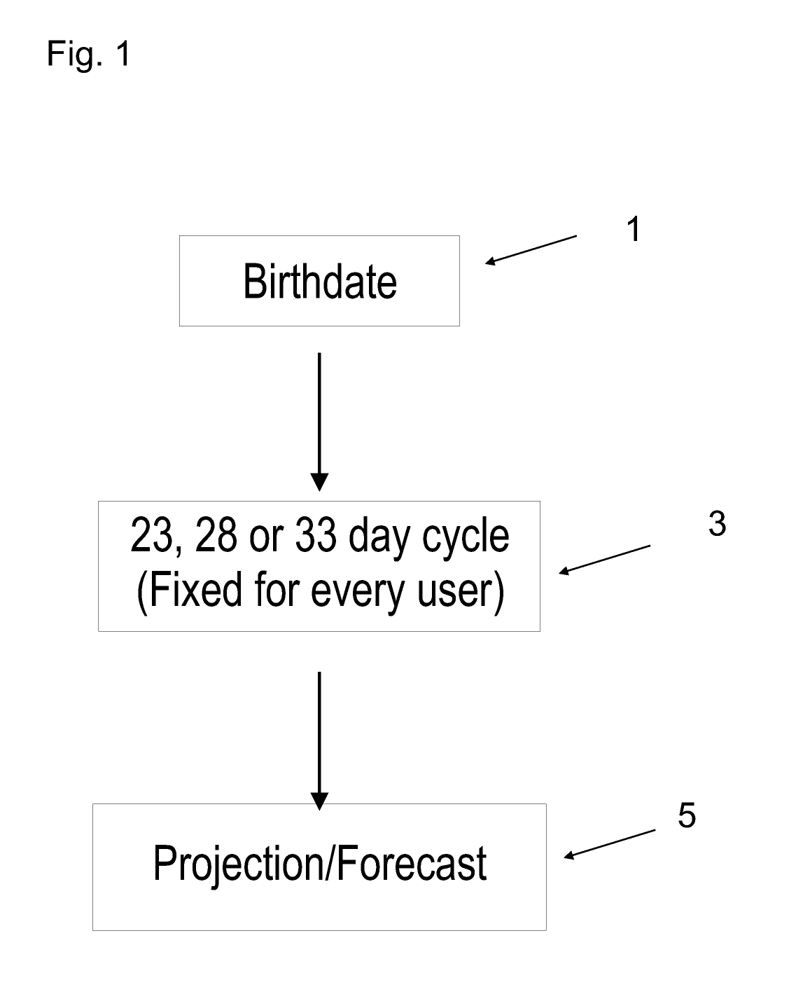

For instance, the present general inventive concept may be used, for example, during planning and/or strategizing of a sports team or the like. A coach may choose to not use or “bench” players who are forecasted by the present general inventive concept to have low performance levels and use other players who are forecasted by the present general inventive concept to have high performance levels, as illustrated in FIG. 1. In this manner, only players having high performance levels will be used, thus increasing the likelihood of a victorious outcome for the sports team. Thus, the present general inventive concept acts to improve overall performance of the sports team.

The present general inventive concept permits a user to forecast performance levels for a period of between 2-6 months into the future. Using the aforementioned example, the coach may use the present general inventive concept to strategize lineups for sporting events 2-6 months into the future.

For example, FIG. 1 illustrates a flowchart wherein a user's birthday 1 is entered, a cycle 3 is selected, and a projection/forecast 5 is generated.

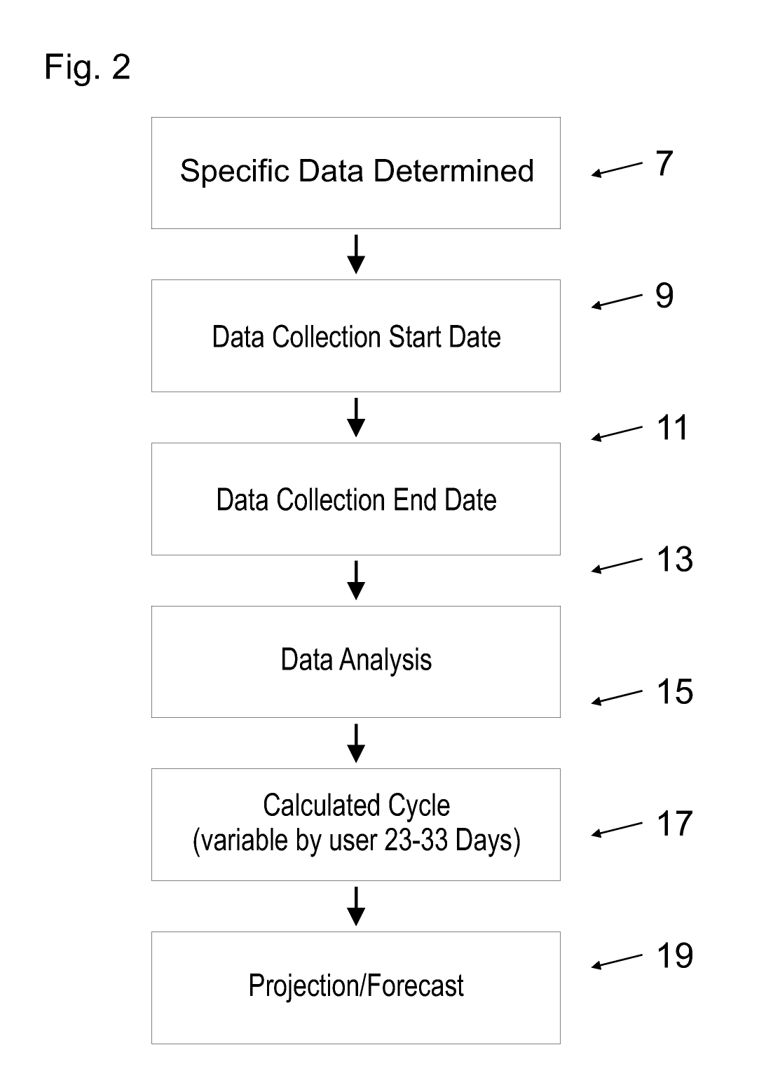

FIG. 2 illustrates a flowchart wherein criteria or data 7 is determined based on selection of user type. Thereafter, data collection 9 begins. It is foreseen that data can be limited to certain periods that may be advantageous, for example, to exclude portions of a user's life that may act to skew the data or focus on portions of a user's life. Data may be eliminated or focused on by providing a data collection start date 9 and/or a data collection end date 11.

Having collected data, data analysis 13 is conducted.

Data cycles 17 are included, which are variable depending on user, and may be 23-33 days and it has been discovered that such variable is likely 28-31 days.

Having completed these steps, a projection/forecast 19 can be generated.

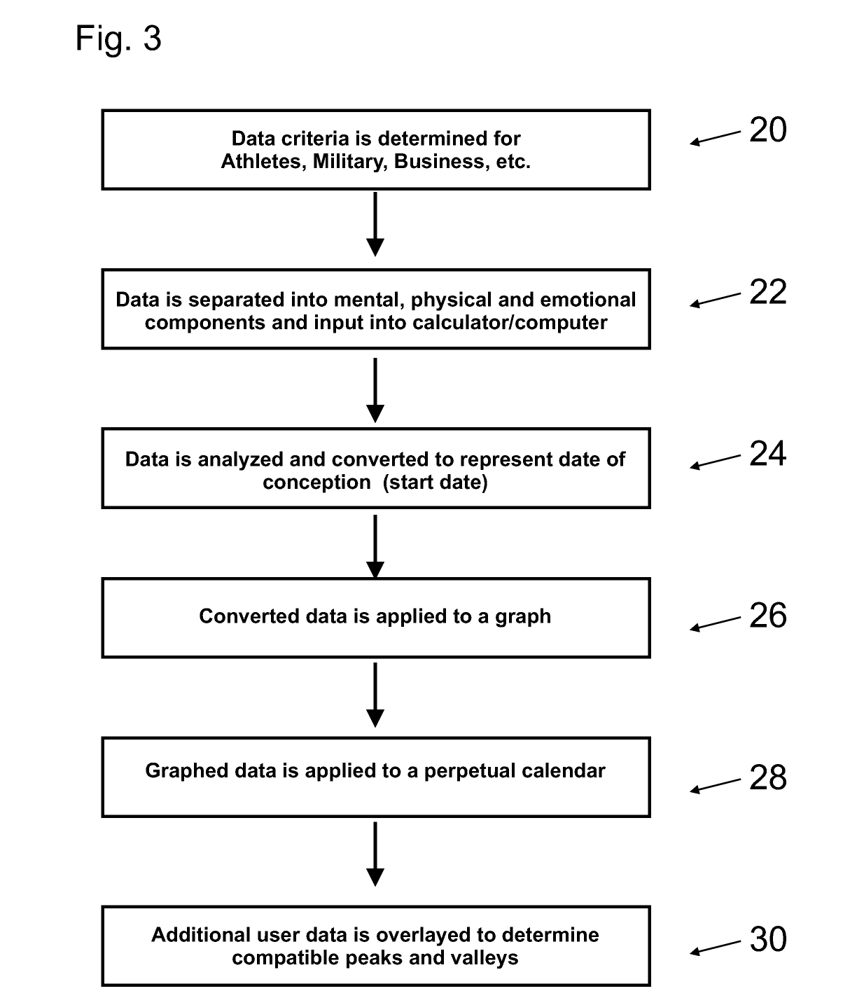

FIG. 3 illustrates a flowchart wherein data criteria is determined based on selection of user type, e.g., athletes, military, business, in step 20.

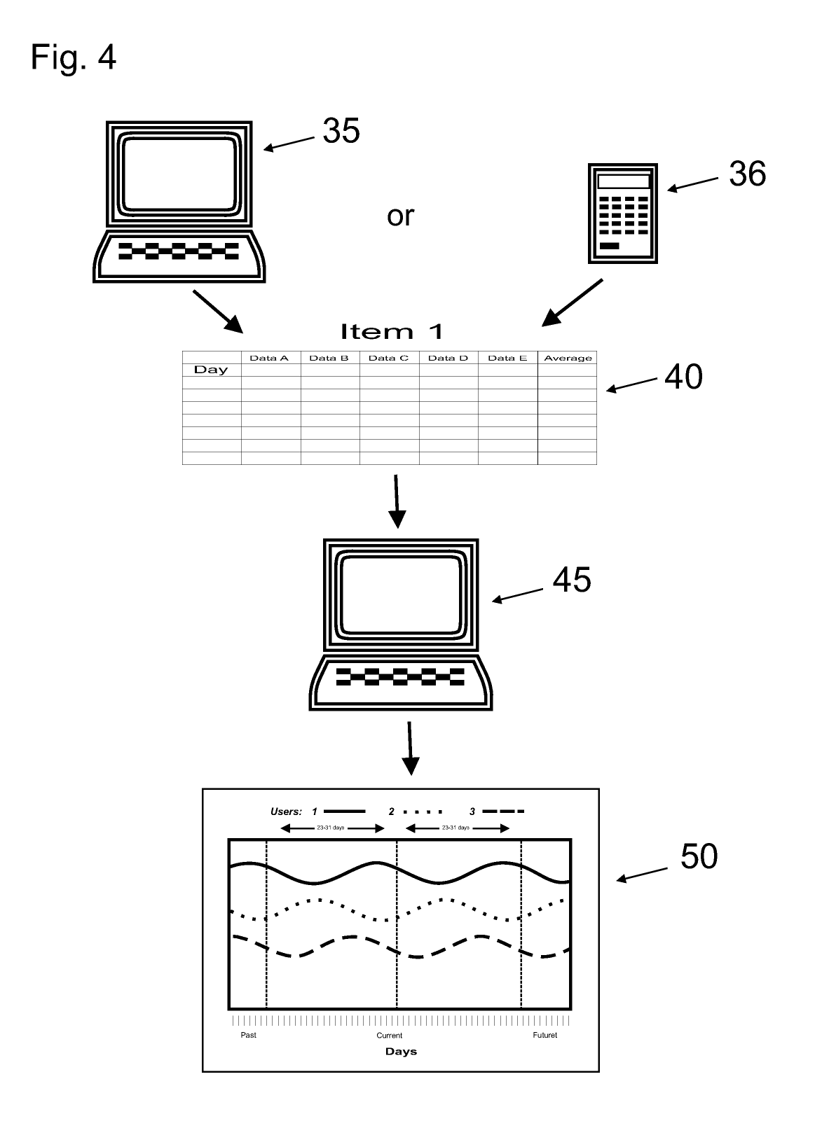

Data is then separated into one of three categories in step 22, i.e., mental, physical, and emotional components, and input into one of a computer 35 or a calculator 36, as illustrated in FIG. 4.

Data is then analyzed and converted to represent data of conception at step 24 i.e. “start date.” Thereafter, data is applied to a graph in step 26, such as graph 70, and then to a perpetual calendar 28 in step 28.

It is foreseen that the mental, physical, and emotional components may be graphed individually or combined. If combined, the present general inventive concept may yield a mean cycle.

Steps 20-28 may then be repeated for each additional user and added to the existing graph 70 during step 30 so that upon entry of data from a final user, the graph 70 simultaneously illustrates each user's data.

FIG. 4 illustrates various devices that may be used to input data such as a computer 35 and/or a calculator 36. Either device 35/36 provides chart 40 to enable entry of data.

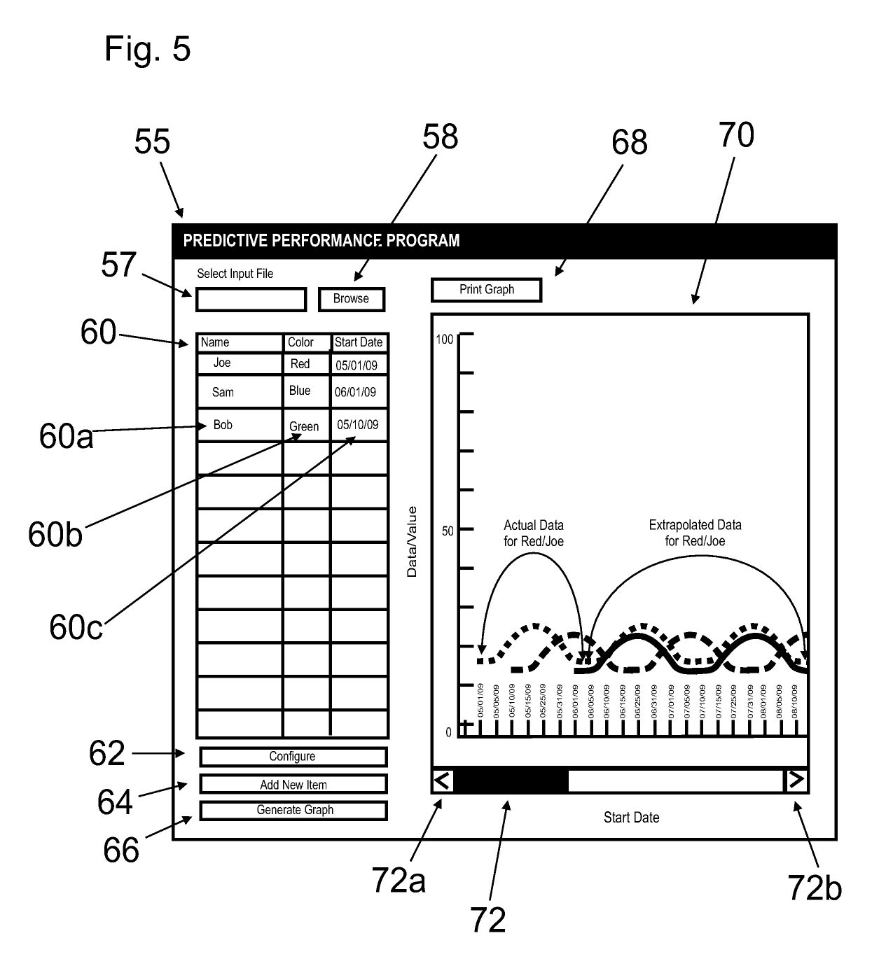

A display of the present general inventive concept is illustrated in FIG. 5, which provides a screen 55.

The processing of the data is then performed by the computer 35 and/or calculator 36 such that a graph 50 is produced.

The screen 55 allows a user to select or input a file in file-selection box 57 so that each use of the present general inventive concept may be recorded. These files, which may be previously saved, may be viewed by selecting “browse” button 58.

User specific information is entered and/or displayed in data area 60, which has, for example, a name column 60a, a user-specific identifier column 60b, and a start date column 60c.

Although “start date” may be manually configured as previously mentioned, the intended default setting is to permit the present general inventive concept to determine a start date based on commonalities within a 60-day graph.

It is foreseen that the present general inventive concept may be used to identify a user's date of conception, which may then be used as the start date.

If manual configuration is desired, upon entry of the data into data area 60, the data may be configured by selecting configure 62.

Additional users may be added by selecting “add new item” 64. It is foreseen that any number of additional users may be added, but at least one is required for analysis.

Upon entry of all data and all users, a graph 70 may be generated by selecting “generate graph” 66. The graph 70 may be scrolled to the left or right along date ranges by respectively selecting scroll buttons 72a or 72b along scroll bar 70.

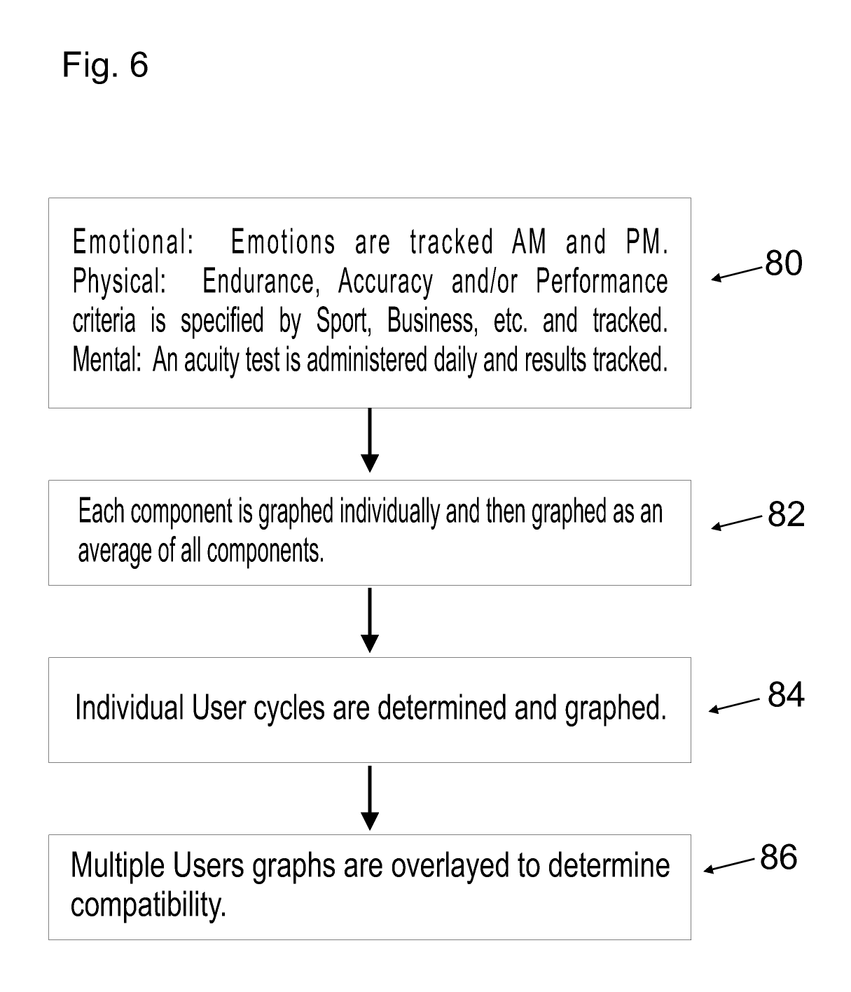

FIG. 6 is a flow chart illustrating various options of the present general inventive concept. For instance, emotion, physical, and mental data are configured in step 80 such that these components may be may be tracked and/or graphed separately in step 82 and individual user cycles are determined and graphed in step 84.

It is foreseen that a daily acuity test may be performed for each user to monitor accuracy of the present general inventive concept and automatically make adjustments to the future performance predictions if the daily acuity test indicates such adjustments are necessary because the previous prediction is inaccurate.

Step 86 permits overlaying of each individual user data onto a single graph to determine compatibility among each of the users.

The present general inventive concept also enables calculation of one's expected or ideal birth date in view of conception of the user.

Given that one's birth date is not a constant due to numerous factors that may cause premature or delayed birth, as previously discussed, upon identification of a user's biorhythms, the present general inventive concept can track the user's past biorhythms to the point at which the biorhythms all meet at a middle point that is at a point proximate to the user's actual birth date, which is input by the user. The middle point will be the user's ideal birth date based on conception of the user, which dates may both be displayed or individually be displayed by the present general inventive concept to the user.

Various embodiments of the present general inventive concept can be embodied as computer readable codes on a computer readable recording medium. The computer readable recording medium may include any data storage device suitable to store data that can be thereafter read by a computer system. Examples of the computer readable recording medium include, but are not limited to, a read-only memory (ROM), a random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion. Various embodiments of the present general inventive concept may also be embodied in hardware or in a combination of hardware and software.

For example, the calculator apparatus of the present general inventive concept may be embodied in software, in hardware, or in a combination thereof. In various embodiments, the calculator apparatus may be embodiment as computer readable codes on a computer readable recording medium to perform information query operation, information input operation, information calculation operation, and information display operation, such as the biorhythm display operation illustrated in FIG. 1.

Although a few embodiments of the present general inventive concept have been illustrated and described, it will be appreciated by those skilled in the art that changes may be made in these exemplary embodiments without departing from the principles and spirit of the general inventive concept, the scope of which is defined in the appended claims and their equivalents.

What is claimed is:

1. A computer readable recording medium comprising computer readable codes to calculate and display a performance level, comprising:
querying a first user multiple times over a first period of time by displaying a set of predetermined questions;
tracking performance of the first user over the first period of time;
displaying a first plurality of fields to permit entry of information specific to the first user;
calculating the performance level based on the information specific to the first user to yield a first personalized result;
analyzing the first personalized result to identify a first user cycle within the first period of time;
forecasting a future performance level based on the first user cycle; and
displaying the first user future performance level in the form of a first graph.

2. The computer readable recording medium according to claim 1, further comprising:
querying a second user multiple times over a first period of time by displaying the set of predetermined questions;
tracking performance of the second user over the first period of time;
displaying a second plurality of fields to permit entry of information specific to the second user;
calculating the performance level based on the information specific to the second user to yield a second personalized result;
analyzing the second personalized result to identify a second user cycle within the first period of time;
forecasting a second user future performance level based on the second user cycle;
displaying the second user future performance level in the form of a second graph;
comparing the first graph with the second graph; and
yielding a determination with respect to whether the performance level of the first user coincides with the performance level of the second user; and
recommending a course of action based on the determination.

3. The computer readable recording medium according to claim 3, wherein if the first user future performance level coincides with the second user future performance level, then a negative indicator is displayed, and if the first user future performance level coincides with the second user future performance level, then a positive indicator is displayed.

4. The computer readable recording medium according to claim 3, wherein the first user future performance level coincides with the second user future performance level if the first user future performance level is aligned with the second user future performance level.

5. The computer readable recording medium according to claim 3, wherein the first user future performance level does not coincide with the second user future performance level if the first user future performance level is not aligned with the second user future performance level.

6. The computer readable recording medium according to claim 1, wherein the information specific to the first user is attributes of the first user.

7. The computer readable recording medium according to claim 1, wherein the first period of time is 60 days.

8. The computer readable recording medium according to claim 1, wherein the set of predetermined questions relates to one of physical, emotional, and mental attributes or all of physical, emotional, and mental attributes of the first user.

9. The computer readable recording medium according to claim 2, wherein the set of predetermined questions relates to one of physical, emotional, and mental attributes or all of physical, emotional, and mental attributes of the second user.

10. The computer readable recording medium according to claim 2, wherein the cycle has a start date of the cycle between 28 and 31 days.

11. The computer readable recording medium according to claim 2, wherein the course of action is to combine the first user and the second user or to separate the first user and the second user.

12. The computer readable recording medium according to claim 2, wherein the course of action is to recommend that the first user and the second user work together in one of an athletic competition, a military initiative, and a business venture, or to recommend that the first user and the second user do not work together in one of an athletic competition, a military initiative, and a business venture.

13. The computer readable recording medium according to claim 1, further comprising:
querying a first user to obtain a date of birth of the first user;
calculating a conception date and an expected birth date; and
displaying one or both of the conception date and an expected birth date to the first user.
